(19) United States
(12) Patent Application Publication
(10) Pub. No.: US 2008/0063845 A1
(43) Pub. Date: Mar. 13, 2008

(54) MULTILAYER STRUCTURES, USES AND PREPARATION THEREOF

(75) Inventor: Vincent Musacchio, Dollard-des-Ormeaux (CA)

Correspondence Address: BERESKIN AND PARR, 40 KING STREET WEST, BOX 401, TORONTO, ON, M5H 3Y2, US

(73) Assignee: EXCEL-PAC INC., Terrebonne (CA)

(21) Appl. No.: 11/854,086

(22) Filed: Sep. 12, 2007

Related U.S. Application Data
(60) Provisional application No. 60/825,278, filed on Sep. 12, 2006.

(51) Int. Cl. B32B 15/082; B29C 65/48

(52) U.S. Cl. 428/212; 156/163; 428/518

(57) ABSTRACT

There is provided a multilayer structure comprising: (i) a heat-resistant outer layer comprising at least one polymer chosen from a polyester, a polypropylene, and mixtures thereof; and (ii) a sealant inner layer comprising at least one metallocene-catalyzed polyethylene, at least one metallocene-catalyzed polyolefin plastomer, or mixtures thereof. The multilayer structure further comprises between the outer an inner layers, in any possible order, a gas barrier layer comprising at least one polyvinylidene chloride polymer, at least one ethylene vinyl alcohol copolymer, or mixtures thereof, and a layer comprising at least one oriented polypropylene polymer. Such a multilayer can be useful for food packaging. There is also provided processes for preparing the multilayer structure.

### FIELD OF THE INVENTION

The present invention relates to improvements in the field of multilayer structures such as those useful for food packaging.

### BACKGROUND OF THE INVENTION

In the packaging of various food products, such as cheese and meat, in a flexible wrapper, difficulty has been experienced with the development of small pinholes in the wrapper at points of stress resulting from flexing of the wrapper during shipment and handling. The pinhole development resulted in a loss of the essential barrier characteristics of the wrapper and resulted in loss or gain of moisture by the package and the access of oxygen into the package with a resultant spoilage of the product intended to be protected and preserved by the wrapper.

A detailed discussion of the problems in this art and one film laminate which solved these problems is set forth in U.S. Pat. No. Re. 28,554, a reissue of U.S. Pat. No. 3,445,324. The wrapping material of the film laminate disclosed in U.S. Pat. No. Re. 28,554 consisted of a wrapping material prepared by bonding to one surface of a cellophane sheet coated on both sides with vinylidene chloride copolymer a biaxially oriented polypropylene sheet and to the other surface a thin layer of low density polyethylene or heat-sealable polymeric material having a melting point below that of the polypropylene. Bonding in that film laminate was accomplished by adhesive or polyethylene lamination.

U.S. Pat. No. 4,421,823 describes a flexible wrapping material comprising a film laminate. Such a wrapping material is used for packaging food products. However, this document relates to a complex multi-pass structure. Moreover, specific manufacturing equipment is required to carry out the method used to prepare such film laminate. Finally, such a film laminate cannot easily be made at low cost.

So far, no solutions have been proposed in order to provide a film packaging that could be easily prepared at low cost and that would offer a good hermetic seal, Hayssens RT “compatibility” (such as cuttability, machineability), flex-crack and pin-hole resistance, gas barrier under moist conditions, grease resistance, and scuff resistance.

### SUMMARY OF THE INVENTION

In accordance with one aspect of the present invention there is provided a multilayer structure comprising:

a heat-resistant outer layer comprising at least one polymer chosen from a polyester, a polypropylene, and mixtures thereof;

a sealant inner layer comprising at least one metallocene-catalyzed polyethylene, at least one metallocene-catalyzed polyolefin plastomer, or mixtures thereof;

wherein the structure comprises between the outer and inner layers, a gas barrier layer comprising at least one polyvinylidene chloride polymer, at least one ethylene vinyl alcohol copolymer, or mixtures thereof, and a layer comprising at least one oriented polypropylene polymer. The gas barrier layer can be comprised between the heat-resistant outer layer and the layer comprising at least one oriented polypropylene polymer, or between the layer comprising at least one oriented polypropylene polymer and the sealant inner layer.

It was found that such a multilayer structure can be useful for packaging and more particularly food packaging. It was found that such a structure permits to obtain an improved flex-crack resistance, an improved sealability (pack integrity), while maintaining good cutability and machineability. This multilayer structure which has a simplified structure as compared to prior art solution so far proposed, demonstrated superior performances. Moreover, it was observed that the percentage of nonconforming packages made with such a structure could be maintained at a very low level.

In accordance with another aspect of the present invention, there is provided a process for preparing a multilayer structure comprising laminating a substrate together with another substrate, the process being characterized in that:

the substrate comprises (i) a heat-resistant layer adapted to serve as an outer layer for the multilayer structure, the heat-resistant layer comprising at least one polymer chosen from a polyester, a polypropylene, and mixtures thereof, and (ii) a gas barrier layer comprising at least one polyvinylidene chloride polymer, at least one ethylene vinyl alcohol copolymer, or mixtures thereof;

the other substrate comprises (i) a layer comprising at least one oriented polypropylene polymer; and (ii) a sealant layer adapted to serve as an inner layer for the multilayer structure and comprising at least one metallocene-catalyzed polyethylene, at least one metallocene-catalyzed polyolefin plastomer, or mixtures thereof.

In accordance with another aspect of the present invention, there is provided a process for preparing a multilayer structure comprising laminating a substrate together with another substrate, the process being characterized in that:

the substrate comprises (i) a heat-resistant layer adapted to serve as an outer layer for the multilayer structure, the heat-resistant layer comprising at least one polymer chosen from a polyester, a polypropylene, and mixtures thereof, and (ii) a layer comprising at least one oriented polypropylene polymer;

the other substrate comprises (i) a gas barrier layer comprising at least one polyvinylidene chloride polymer, at least one ethylene vinyl alcohol copolymer, or mixtures thereof; and (ii) a sealant layer adapted to serve as an inner layer for the multilayer structure and comprising at least one metallocene-catalyzed polyethylene, at least one metallocene-catalyzed polyolefin plastomer, or mixtures thereof.

It was found that the latter two processes are useful for preparing multilayer structures that can be used for packaging and more particularly for food packaging. It was also found that such a process permits to prepare multilayer structures having improved properties such as improved flex-crack resistance, an improved sealability (pack integrity), while maintaining a good cutability and machineability. Moreover, it was observed that such processes permitted to maintain the percentage of nonconforming packages at a very low level.

The heat-resistant outer layer can comprise a biaxially oriented polyester film. It can also comprise an amorphous bonding layer, a co-extruded polyester, or a mixture thereof. The heat-resistant outer layer can be adapted to be cut with a blade. The person skilled in the art would clearly recognize the polymers that would be suitable for use in the heat-resistant layer. For example, such polymers can comprise polyesters and/or polypropylenes having a melting point of at least about 130°C.

The sealant inner layer can be a heat-sealable inner layer. The sealant inner layer can have a density of about 0.89 to about 0.93 g/cm³. It can also have a density of about 0.91 g/cm³. The sealant inner layer can comprise about 5% to about 75% by weight of the at least one metallocene-catalyzed polyethylene, or at least one metallocene-catalyzed polyolefin plastomer. Alternatively, it can comprise about 10% to about 50% by weight of at least one metallocene-catalyzed polyethylene, or the at least one metallocene-catalyzed polyolefin plastomer.

The multilayer structures of the present invention can further comprise an ink layer. The structures can comprise an ink layer disposed between the gas barrier layer and the layer comprising at least one oriented polypropylene polymer. The structures can further comprise an adhesive layer disposed between the gas barrier layer and the layer comprising at least one oriented polypropylene polymer. The structures can alternatively comprise an adhesive layer disposed between the ink layer and the layer comprising at least one oriented polypropylene polymer.

For example, the multilayer structures of the present invention can comprise, sequentially, the heat-resistant outer layer; the gas barrier layer; the layer comprising at least one oriented polypropylene polymer; and the sealant inner layer. In another example, the structures can comprise, sequentially, the heat-resistant outer layer; the layer comprising at least one oriented polypropylene polymer; the gas barrier layer; and the sealant inner layer.

In another example, the multilayer structures can comprise, sequentially, the heat-resistant outer layer; the gas barrier layer; optionally an ink layer; optionally an adhesive layer; the layer comprising at least one oriented polypropylene polymer; and the sealant inner layer.

In another example, the multilayer structures can comprise, sequentially, the heat-resistant outer layer; the gas barrier layer; optionally an ink layer; optionally an adhesive layer; a bonding layer comprising at least one metallocene-catalyzed polyethylene; the layer comprising at least one oriented polypropylene polymer; and the sealant inner layer.

In another example, the multilayer structures can comprise, sequentially, the heat-resistant outer layer; the gas barrier layer; optionally an ink layer; optionally an adhesive layer; and a three layer extrudate of a bonding layer comprising at least one metallocene-catalyzed polyethylene; the layer comprising at least one oriented polypropylene polymer; and the sealant inner layer.

The bonding layer can comprise at least one metallocene-catalyzed polyethylene having a density of about 0.89 to about 0.93 g/cm³. Alternatively, the bonding layer can comprise at least one metallocene-catalyzed polyethylene having a density of about 0.91 g/cm³.

An adhesive substrate can be used and disposed between the substrates. The adhesive can be applied on at least one of the substrates and then the substrates are laminated together. The adhesive can be applied to the substrate. For example, the substrate can be coated with the adhesive. The adhesive can be coated by using an adhesive roll pressure. The adhesive can be coated at a pressure of about 2 to about 6 bar. Alternatively, the adhesive can be coated at a pressure of about 3.5 to about 5.5 bar. An adhesive can be applied on at least one of the substrates and then, the substrates are laminated together by means of a nip roll. The substrates can be laminated at a pressure of about 2 to about 6 bar. The substrates can be laminated at a pressure of about 3.5 to about 4.5 bar. The nip roll can be heated at a temperature at least 20° C. Alternatively, the nip roll can be heated at a temperature of about 45 to about 55° C. The heat-resistant layer can comprise a biaxially oriented polyester film. The processes of the present invention can further comprise curing the obtained multilayer structure. The curing can be carried out for a period of at least 1 day. For example, the curing can also be carried out for a period of at least 5 days. Alternatively, the curing can be carried out for a period of about 5 to about 10 days.

In the present invention, the polypropylene used can be, for example, propylene polymers including isotactic PP, and PP co and terpolymers containing alpha olefins such as ethylene and butylene. Other examples of polypropylene include syndiotactic PP based polymers and isotactic PP with a PP co E blend.

### BRIEF DESCRIPTION OF THE DRAWINGS

In the drawings which represent by way of example only some particular embodiments of the invention:

FIG. 1 is a schematic top view representation of the position, on pallet, of boxes containing multilayer structures according to particular embodiments of the present invention and prior art multilayer structures, during comparative conformity tests that were carried out on these multilayer structures, each square representing a pile of seven boxes, the structures being represented by the terms B1, B2, C1, C2, D1 and D2;

FIG. 2 is a schematic side view representation of piles of boxes, numbered from 1 to 14, containing the multilayer structures defined in FIG. 1, wherein each pile contains seven boxes;

FIG. 3 is a schematic side view representation of the position of the multilayer structures of FIG. 1 in the boxes; and

FIG. 4 is a conformity comparison chart concerning the multilayer structures of FIG. 1.

### DETAILED DESCRIPTION OF THE INVENTION

The present invention will be more readily understood by referring to the following examples, which are given to illustrate the invention rather than to limit its scope.

The multilayer structures of the present invention can be made in various manners. The following general method, presented in a non-limitative manner, was used to prepare few multilayer structure films.

### EXAMPLE 1

### Structure B1

A multilayer structure for food packaging was prepared by laminating together two films (Film 1 and Film 2) by using a solventless adhesive and a Roll Durometer 80. Film 1 was 48 ga Biaxially stretched PET which has been PVDC coated (terphane 22.00). Film 2 was a 2.5 mil multilayer film of 0.91 g/cm³ density comprising 20% with a metallocene linear surface with a density of 0.918 g/cm³, 60% polypropylene core 0.90 g/cm³ density and 20% plastomer blend 0.90 g/cm³. The adhesive was made of HB Fuller™ and WD4110 A/B (ratio 1:2), 0.9-1.2 lbs/ream.

The printed film (Film 1) was coated with the adhesive and then, Film 2 was applied to it using a heated nip roll. Tension control was verified so as to provide an even coating thickness and avoid any creasing and curl. After curing (up to 10 days) the obtained multilayer structure; Polyester/PVDC//ink/adhesive//mLLd PE/PP/POP blend was then slit and the edges were removed and the printed laminated structure was available for testing. The typical conditions used for the lamination process are as follows:

| Parameters | Target | Min | Max |
|---|---|---|---|
| Speed: (m/min) | 220 | — | 240 |
| Premix Temperature: (° F.) | 110 | 105 | 120 |
| Adhesive Temperature: ° C. | 63 | 62 | 64 |
| Nip Temperature: ° C. | 50 | 46 | 54 |
| Adhesive Roll Pressure: Bar | 5.5 | 3.5 | 4.5 |
| Nip Roll Pressure: Bar | 4 | 3.5 | 4.5 |
| Rewind Pressure: Bar | 4 | 3.5 | 4.5 |
| Corona A (3.5 KW = 100%): | 40.0 | 14 | 18 |
| Corona B (3.5 KW = 100%): | 60.0 | 5 | 9 |
| Adhesive Coat Weight: | 1.0 | 0.9 | 1.2 |

Tests have been performed on films made with the previously mentioned structure (see Films B1 and B2).

Structure B2 was identical to B1 except the gauge of Film 2 was 2.75 mil rather than 2.5 mil in thickness.

Structure C1 consists Film 1 laminated to a 50 ga polypropylene (Vifan BTL) film that was again laminated to a single layer polyethylene film (2.0 mil UILM 41HI made by Pliant Corporation).

Structure C2 consists of Film 1 laminated to a single layer polyethylene film (2.0 mil UILM 41HI made by Pliant Corporation)

Six films used for packaging sliced cheese were tested and compared. The packaged product was Havarti cheese 160 g. The films have been printed so as to represent the actual manufacturing conditions.

The purpose of this test was to evaluate different films used for packaging cheese in order to determine the optimal structure for this application.

### Experimental Methodology

### Testing Procedure

Product: Havarti cheese 160 g
Equipment Description: Hayssen RT-1000 MAP 1999
Lot Size: 168 packages/lot
Packaging Box: Packaging box 1973, no coating, 10 ¾″×10″×4 ¾″
Transportation Package: Regular pallet CPC 40″×48″
Control Lot: Two control lots were used, the first one with the current Excel Pac structure (lot D1) and the second one with the current Curwood structure (D2). These lots are produced in parallel with the DOE.
DOE Evaluation: The test matrix was randomly selected in order to eliminate all parameters related to time. The operator confirms that no particular maintenance has been performed on the equipment, which represents normal production conditions.

### Machine Parameters

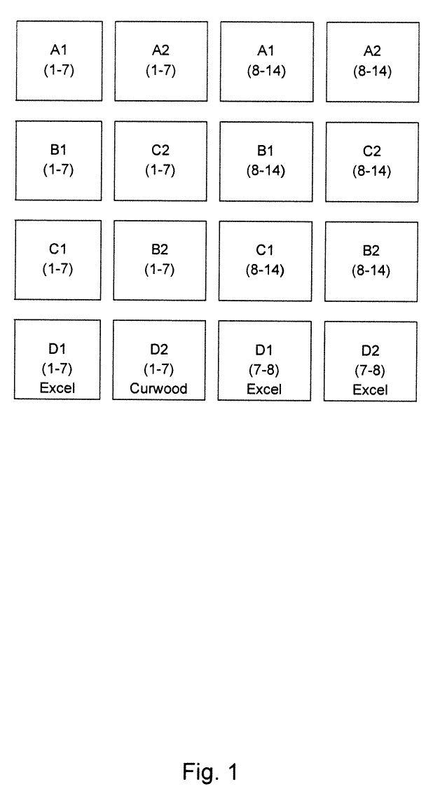

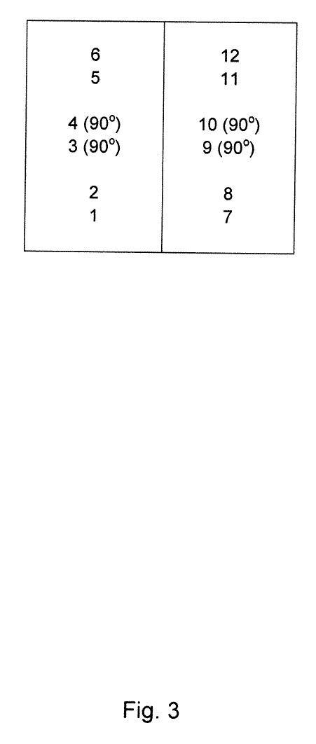

Parameters
Cycle Duration: 35 cycles/min. (9 packages/rotation)
Gas Flow Rate: 1.5 SCFM
Composition: 100% CO₂
Anti-Static Bar: No
Jaws
Type: Linear at 7 bands with cuts at ¾
Bottom Jaw Temp.: 235° F.
Top Jaw Temp.: 135° F.
Back Jaw Temp.: 330° F.
Pressure: 80 PSI, pneumatic
Sealing Time: 6 seconds
Description of Packaging Material
Packaging Box: #1973, no coating, 10 ¾″×10″×4 ¾″
Packaging Box Coating: None
Pallet Size: CPC 40″×48″
Position of Boxes on Pallet: See FIG. 1
Position of Pouches in Box: Two rows of six pouches, see FIG. 3

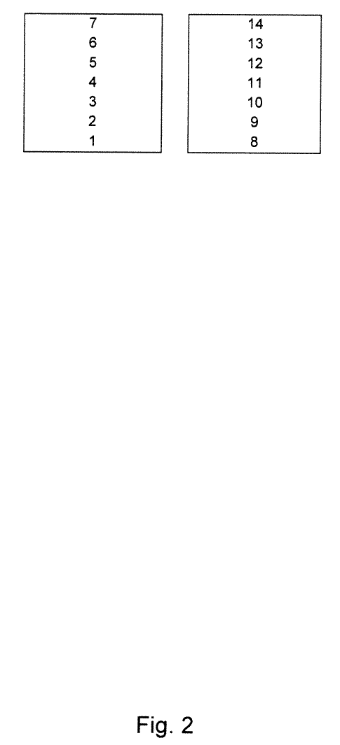

It has to be noted that this represents the initial position of boxes (see FIGS. 1 to 3). After the first 72-hours evaluation, piles have kept their location on the pallet but the box pile order has been changed (inversed).

### Inspection Process

Three levels of inspection or control were carried out in order to evaluate the properties of different films.

The first inspection was carried out after packaging the product. Ten empty pouches were randomly selected and vacuum testing was carried out with a vacuum leak at 20 inchHg.

The second inspection was carried 72 hours after packaging to ensure a sufficient delay for nonconformities to appear.

The third inspection was carried out 7 days after packaging, including the transportation (3 round trips Montreal/Toronto). The pouches are subject to greater condition constraints in this third inspection.
Inspection at 0 hour: Ten (10) empty pouches have been tested. All of these pouches were compliant. As for the packed product, three (3) pouches have been tested. However, the gas flow rate needed to be increased in order to have a sufficient amount of gas to perform the vacuum leak test.
Inspection after 72 hours: 100% of all pouches have been tested. The testing was visually carried out.
Inspection after 7 days: 100% of all pouches that have been subject to transportation have been tested (3 round trips from Montreal to Toronto). Vacuum leak testing was carried out over a period of two days.
   In order to detect defects or nonconformities, a known air quantity was injected in the pouches.

### Test Matrix

Six films were tested. The fifth lot is the control lot with the current Excel Pac product (Excel Pac lot #7698) and the sixth lot is the control lot with a prior art product.
a) Excel B1, gauge of 3.00 mils
b) Excel B2, gauge of 3.25 mils
c) Excel C1, gauge of 2.50 mils,
d) Excel C2, gauge of 3.00 mils
e) Excel D1, Havarti 160 g. current structure (control) with a gauge of 2.50 mils
f) Curwood D2, control structure, gauge of 3.00 mils

It has to be noted that the films submitted meet the sealing specifications of the product currently submitted.

### Results

### Definition of Various Types of Defects

Pin hole: micro-perforation in the film, may be described as a cut by a sharp object but generally of a very small diameter, almost invisible to the eye.

Zipper: leaker located in the film at the intersection of the zipper and the films.

Channel leaker/leaker: leaker located in the sealing parts (inferior or superior), causing an air leak in that section. The Channel leaker is characterized by a lack of sealing that goes across the sealing band. It is possible to see it visually.

Cheese seal: leaker due to the presence of a particle of cheese in the sealing section.

Back seal: leaker located in the back sealing section of the film.

Fin seal: leaker located at the intersection of the back seal and the transversal sealing parts.

Corner crack: leaker located at the junction of the superior or the inferior seal with the side of the bag. The corner crack is characterized by a zone where abrasion and mechanical flexing are very high.

### Inspection at 0 Hour

No nonconformity, leaker, was found during the testing on empty pouches or cheese-filled pouches. No mechanical adjustment was needed during these tests.

### Inspection After 72 Hours

TABLE 1
Nonconformities after 72 hours
(by visual inspection not vacuum testing)

| | | Quantity of | |
|---|---|---|---|
| Lot | Sample Size | Nonconforming Packs | % |
| B1 | 168 | 16 | 9.5 |
| B2 | 168 | 8 | 4.8 |
| C1 | 168 | 16 | 9.5 |
| C2 | 168 | 15 | 8.9 |
| D1 | 168 | 25 | 14.9 |
| D2 | 168 | 9 | 5.4 |

### Inspection After 7 Days Including Transportation

TABLE 2
Nonconformities

| | Quantity of | | | | |
|---|---|---|---|---|---|
| | Nonconforming | Sample | | | |
| Lot | Packs | Size | % | Description | % Type |
| B1 | 5 | 168 | 3.0% | Zipper | (1) 0.6% |
| | | | | Leaker/Channel | (1) 0.6% |
| | | | | Cheese seal | (2) 1.2% |
| | | | | Corner crack | (1) 0.6% |
| B2 | 4 | 168 | 2.4% | Zipper | (1) 0.6% |
| | | | | Leaker/Channel | (1) 0.6% |
| | | | | Fin seal | (1) 0.6% |
| | | | | Back seal | (1) 0.6% |
| C1 | 26 | 168 | 15.5% | Zipper | (9) 5.4% |
| | | | | Pin hole | (6) 3.6% |
| | | | | Leaker/Channel | (7) 4.2% |
| | | | | Fin seal | (1) 0.6% |
| | | | | Back seal | (3) 1.8% |
| C2 | 17 | 168 | 10.2% | Zipper | (5) 3.0% |
| | | | | Pin hole | (2) 1.2% |
| | | | | Leaker/Channel | (2) 1.2% |
| | | | | Fin seal | (2) 1.2% |
| | | | | Back Seal | (4) 2.4% |
| | | | | Corner crack | (2) 1.2% |
| D1 | 22 | 168 | 13.1% | Zipper | (12) 7.1% |
| | | | | Pin hole | (2) 1.2% |
| | | | | Leaker/Channel | (6) 3.6% |
| | | | | Back seal | (1) 0.6% |
| | | | | Corner crack | (1) 0.6% |
| D2 | 26 | 168 | 15.5% | Zipper | (3) 1.8% |
| | | | | Pin hole | (2) 1.2% |
| | | | | Leaker/Channel | (11) 6.5% |
| | | | | Fin seal | (8) 4.7% |
| | | | | Back seal | (1) 0.6% |
| | | | | Corner crack | (1) 0.6% |

### Film Inspection

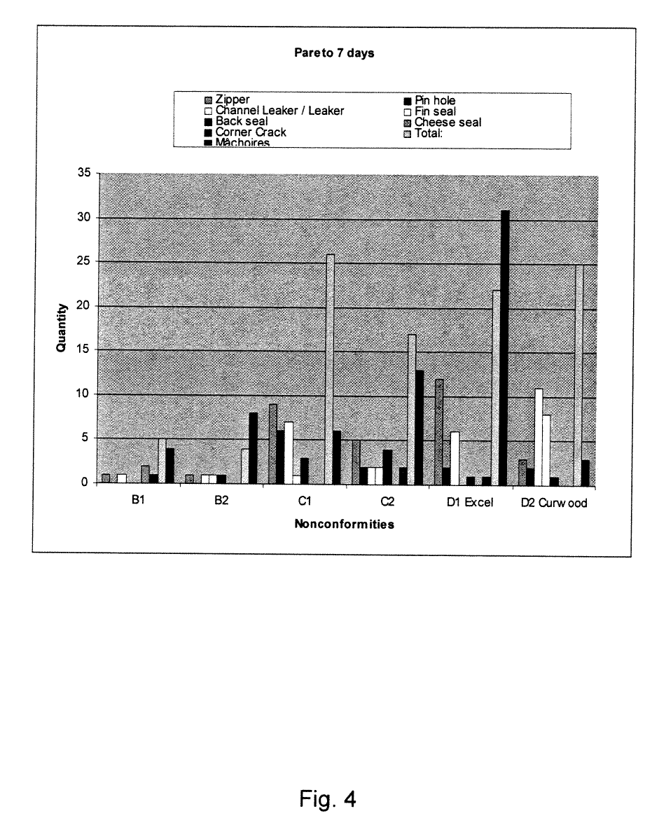

As can be seen from the previous test and FIG. 4, films B1 and B2 are two excellent choices for the type of product packaged. Their rate of nonconformity is considerably low. Moreover, these films, although more rigid, have performed very well on the production equipment and no adjustment was required. Those thicker films also improve the appearance of the product.

Concerning the inspection right after packaging (at 0 hour), all the film have well performed. As for the inspection after 72 hours, this test cannot be used to quantify the performance of a film since it is extremely difficult to evaluate this type of packaging without using a vacuum leak tool. Since the pouches are basically flat, the vacuum leak test is impossible to perform.

After 7 days including transportation, films B1 and B2 have a nonconformity rate of 3.0 and 2.4% respectively, when submitted to the vacuum leak test at 20 inchHg, which exceeds the norms of the industry, 15 inchHg being the standard (information from Packaging Association of Canada (PAC)). These films are superior to the other films as well as those used as controls, films D1 and D2 (current Excel Pac and Curwood structures, respectively).

Summary table of nonconformities after 7 days including transportation

| | Quantity of | Sample | % |
|---|---|---|---|
| Lot | Nonconformities | Size | Nonconformity |
| B1 | 5 | 168 | 3.0% |
| Total Thickness of 3.0 Mil | | | |
| B2 | 4 | 168 | 2.4% |
| Total Thickness of 2.5 Mil | | | |
| D1 | 22 | 168 | 13.1% |
| Total Thickness of 2.5 Mil | | | |
| D2 | 26 | 168 | 15.5% |
| Total Thickness of 3.0 Mil | | | |

Moreover, the stiffness of films B1 and B2 permitted to avoid the problem of sealing in undesirable locations (sealing jaw). It was noted that portions of many pouches have sealed in undesirable locations (outside the sealing bands) because of their contact with hot parts of the equipment. All films with gauges around 3.0 Mils have performed better on this point.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

What is claimed is:

1. A multilayer structure comprising:
a heat-resistant outer layer comprising at least one polymer chosen from a polyester, a polypropylene, and mixtures thereof;
a sealant inner layer comprising at least one metallocene-catalyzed polyethylene, at least one metallocene-catalyzed polyolefin plastomer, or mixtures thereof;
wherein said structure comprises between said outer an inner layers, a gas barrier layer comprising at least one polyvinylidene chloride polymer, at least one ethylene vinyl alcohol copolymer, or mixtures thereof, and a layer comprising at least one oriented polypropylene polymer, said gas barrier layer being comprised between said heat-resistant outer layer and said layer comprising at least one oriented polypropylene polymer, or between said layer comprising at least one oriented polypropylene polymer and said sealant inner layer.

2. The multilayer structure of claim 1, wherein said heat-resistant outer layer comprises a biaxially oriented polyester film.

3. The multilayer structure of claim 1, wherein said heat-resistant outer layer further comprises an amorphous bonding layer.

4. The multilayer structure of claim 1, wherein said heat-resistant outer layer further comprises a co-extruded polyester.

5. The multilayer structure of claim 1, wherein said sealant inner layer is a heat-sealable inner layer.

6. The multilayer structure of claim 1, wherein said sealant inner layer has a density of about 0.89 g/cm³ to about 0.93 g/cm³.

7. The multilayer structure of claim 1, wherein said sealant inner layer comprises about 5% to about 75% by weight of said at least one metallocene-catalyzed polyethylene, or said at least one metallocene-catalyzed polyolefin plastomer.

8. The multilayer structure of claim 1, wherein said structure further comprises an ink layer.

9. The multilayer structure of claim 1, wherein said structure comprises, sequentially, said heat-resistant outer layer; said gas barrier layer; said layer comprising at least one oriented polypropylene polymer; and said sealant inner layer.

10. The multilayer structure of claim 1, wherein said structure comprises, sequentially, said heat-resistant outer layer; said layer comprising at least one oriented polypropylene polymer; said gas barrier layer; and said sealant inner layer.

11. A process for preparing a multilayer structure comprising laminating a substrate together with another substrate, said process being characterized in that: either
said substrate comprises (i) a heat-resistant layer adapted to serve as an outer layer for said multilayer structure, said heat-resistant layer comprising at least one polymer chosen from a polyester, a polypropylene, and mixtures thereof, and (ii) a gas barrier layer comprising at least one polyvinylidene chloride polymer, at least one ethylene vinyl alcohol copolymer, or mixtures thereof; and
said other substrate comprises (i) a layer comprising at least one oriented polypropylene polymer; and (ii) a sealant layer adapted to serve as an inner layer for said multilayer structure and comprising at least one metallocene-catalyzed polyethylene, at least one metallocene-catalyzed polyolefin plastomer, or mixtures thereof; or
said process being characterized in that:
said substrate comprises (i) a heat-resistant layer adapted to serve as an outer layer for said multilayer structure, said heat-resistant layer comprising at least one polymer chosen from a polyester, a polypropylene, and mixtures thereof, and (ii) a layer comprising at least one oriented polypropylene polymer;
said other substrate comprises (i) a gas barrier layer comprising at least one polyvinylidene chloride polymer, at least one ethylene vinyl alcohol copolymer, or mixtures thereof; and (ii) a sealant layer adapted to serve as an inner layer for said multilayer structure and comprising at least one metallocene-catalyzed polyethylene, at least one metallocene-catalyzed polyolefin plastomer, or mixtures thereof.

12. The process of claim 11, wherein an adhesive is further applied on at least one of said substrates and then said substrates are laminated together.

13. The process of claim 11, wherein said heat-resistant layer comprises a biaxially oriented polyester film.

14. The process of claim 11, wherein said heat-resistant layer further comprises an amorphous bonding layer.

15. The process of claim 11, wherein said heat-resistant layer further comprises a co-extruded polyester.

16. The process of claim 11, wherein said sealant layer is a heat-sealable layer.

17. The process of claim 11, wherein said sealant layer has a density of about 0.89 to about 0.93 g/cm³.

18. The process of claim 11, wherein said sealant layer comprises about 5% to about 75% by weight of said at least one metallocene-catalyzed polyethylene, or said at least one metallocene-catalyzed polyolefin plastomer.

19. The process of claim 11, wherein said substrate further comprises an ink layer.

20. The process of claim 12, wherein said prepared structure comprises, sequentially, said heat-resistant layer; said gas barrier layer; an adhesive layer; said layer comprising at least one oriented polypropylene polymer; and said sealant layer.

21. The process of claim 11, wherein said structure comprises, sequentially, said heat-resistant layer; said layer comprising at least one oriented polypropylene polymer; said gas barrier layer; and said sealant layer.

22. The process of claim 11, wherein said bonding layer comprising at least one metallocene-catalyzed polyethylene has a density of about 0.89 to about 0.93 g/cm³.

23. The multilayer structure of claim 1, wherein the polypropylene is chosen from propylene polymers including isotactic PP, and PP co and terpolymers containing alpha olefins such as ethylene and butylenes, syndiotactic PP based polymers, and isotactic PP with a PP co E blend.

24. The process of claim 11, wherein the polypropylene is chosen from propylene polymers including isotactic PP, and PP co and terpolymers containing alpha olefins such as ethylene and butylenes, syndiotactic PP based polymers, and isotactic PP with a PP co E blend.

25. A multilayer structure obtained by a process as defined in claim 11.
